(19) United States
(12) Patent Application Publication
(10) Pub. No.: US 2008/0100460 A1
(43) Pub. Date: May 1, 2008

(54) False Ceiling Fire Detector Assembly

(76) Inventors: Lorenzo Luterotti, Gorizia (IT); Mauro Ceppa, Muggia (IT)

Correspondence Address: HONEYWELL INTERNATIONAL INC., 101 COLUMBIA ROAD, P O BOX 2245, MORRISTOWN, NJ, 07962-2245, US

(21) Appl. No.: 11/554,225

(22) Filed: Oct. 30, 2006

(51) Int. Cl. G08B 17/00

(52) U.S. Cl. 340/584

(57) ABSTRACT

A mounting apparatus usable with ambient condition detectors includes first and second mounting bases spaced apart axially along a common center line. Respective detectors can be coupled to the bases as required in a specific installation.

### FIELD

The invention pertains to ambient condition detectors. More particularly, the invention pertains to structures which incorporate a plurality of spaced apart detectors for monitoring adjacent separate ambient regions.

### BACKGROUND

False ceilings are commonly found in commercial and industrial structures. They are particularly useful in that utilitarian structures such as conduits, brackets, fixtures and the like can be recessed therein but continue to be readily accessible. False ceilings also provide an enhanced aesthetic appearance since all of the necessary utilitarian structures are out of sight in the space between the false or drop ceiling and the true ceiling of the region.

In some instances, fire codes require that sensors be installed in any separate ambient. Regions with a false ceiling constitute two different ambients which may need to be monitored. Hence, not only must ambient condition detectors be mounted on false ceilings, they must also be mounted in the utilitarian region above the false ceiling.

Such recessed or hidden detectors can be inconvenient, expensive, and can create maintenance problems. While such recessed detectors can be readily installed before the false ceilings are installed, they must be readily available after the fact for inspection. A known solution to the problem is to provide an inspection trap door which can also be inconvenient and not cost effective.

There is a continuing need, as a result, for structures or methods which make it possible to readily install and inspect detectors in limited access regions, for example, above false ceilings, in a way which is both cost effective and in accordance with the desired aesthetics of the region. It would also be desirable that such devices and methods do not substantially affect the cost of the associated detectors.

### BRIEF DESCRIPTION OF THE DRAWINGS

FIG. 1 is an overall perspective-type view of an apparatus in accordance with the invention;

FIG. 2 is a side elevational view of the apparatus of FIG. 1;

FIG. 3 is yet another view of an apparatus which embodies the invention which is mounted on a drop or false ceiling; and

FIG. 4 is a diagram of a structure for carrying two spaced-apart detectors, releasably coupled thereto, in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

An apparatus which embodies the invention couples first and second detectors together axially so one of the detectors can be installed such that it extends from a normally visible surface of a false ceiling. In this embodiment, the second, axially displaced, detector is operatively position in the utilitarian space above the false ceiling.

In another aspect of the invention, the detectors can be mounted spaced apart from one another using a plurality of adjustable spacing elements. As a result, the different dimensions of utilitarian spaces above the false ceiling can be taken into account.

Each of the detectors can be releasably mounted on a standard mounting base. The respective bases can be in wired or wireless communication with a regional alarm system. Those of skill will understand that the characteristics and particular details of the associated alarm system are not limitations of the present invention.

In accordance with the invention, the two detectors are installed by attaching one of the two to the associated false ceiling with the other of the two extending axially above the false ceiling into the utilitarian space. Structures which embody the present invention are particularly advantageous in that no inspection trap door is needed and no special double wall base mount is required. Rather, the entire unit can be removed from the ceiling by uncoupling same from the exposed side of the false ceiling. Both detectors are removable at the same time for maintenance and test purposes. Either one can be removed from its respective base and replaced. The entire unit can then be reinstalled by attaching the relevant detector to the mount on the false ceiling.

Structures in accordance with the present invention can be used with a variety of different types of ambient condition detectors. These include, without limitation, smoke, gas, fire, thermal and condensation detectors. It will also be understood that the details of such detectors are not limitations of the present invention.

It will also be understood that support structures in accordance with the invention can be used to support two different types of ambient condition detectors such as a smoke detector and a thermal detector as the application requires. Other combinations of detectors come within the spirit and scope of the present invention.

In yet another aspect of the invention, one of the bases can be replaced with a decorative ceiling plate or a light fixture. In such instances, the detector at the other end, on installation, is located in the utilitarian space between the drop ceiling and the actual ceiling of the region.

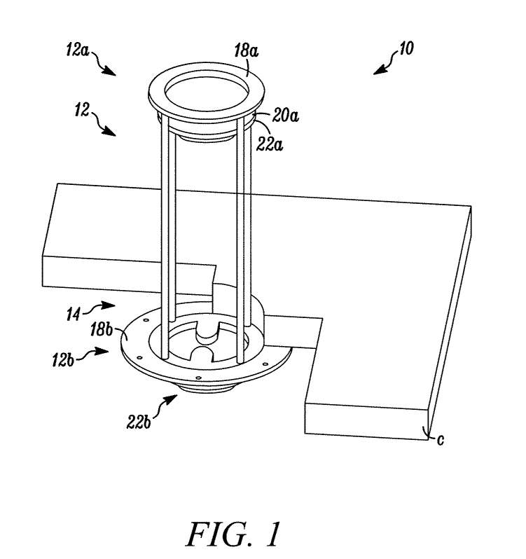

FIG. 1 illustrates an apparatus 10 which embodies the present invention. The apparatus includes a support structure 12 having first and second ends 12a,12b. The ends 12a,12b can be moved toward one another or apart from one another axially as needed on a set of tubular members generally indicated at 14.

End 12a carries an annular ring-shaped member 18a to which is affixed a base 20a for a selected form of ambient condition detector. The form of detector could include without limitation smoke detectors, gas detectors, fire detectors and the like all without limitation.

A selected form of ambient condition detector 22a is releasably coupled to the base 20a. A second detector 22b can be releasably coupled to the base 20b.

The configuration 10 can be mounted in a drop ceiling C using the annular member 12b. When so configured, detector 22a senses conditions in the ambient region on one side of the ceiling, C, whereas the detector 22b senses ambient conditions on the other side of the ceiling C. This is a convenient and cost-effective arrangement whereby the region above the ceiling C can be monitored on an ongoing basis using standard detectors. The structure 10 is particularly advantageous in that from an aesthetic and cost-effectiveness point of view it can be readily removed from the ceiling C to provide access to the detector 22a for inspection and maintenance purposes. Additionally, unit 10 can be used in a variety of different installations where the drop or false ceiling C is located at different distances from the actual ceiling in that region. The bases 20a,b can be moved together or spaced apart as needed.

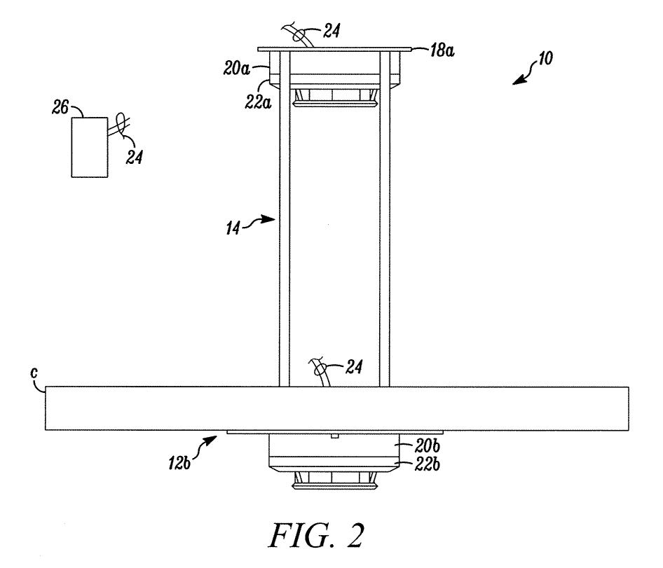

Detectors 22a, 22b can be coupled by medium 24 to a displaced monitoring system 26, illustrated in FIG. 2. It will be understood that neither the medium 24 nor the characteristics of the monitoring system 26 are limitations of the invention.

The medium 24 can be wired or wireless. Additionally, if wired, the electrical conductors, can be either brought directly to each of the bases 20a, b or to a terminal block associated with annular ring 18a for connection to both detectors. In that embodiment, the apparatus 10 would include conductors which extend from the connector block on the ring 18a to the base 20b. It will be understood by those of skill in the art that the details of coupling to the bases 20a, b are not limitations of the invention.

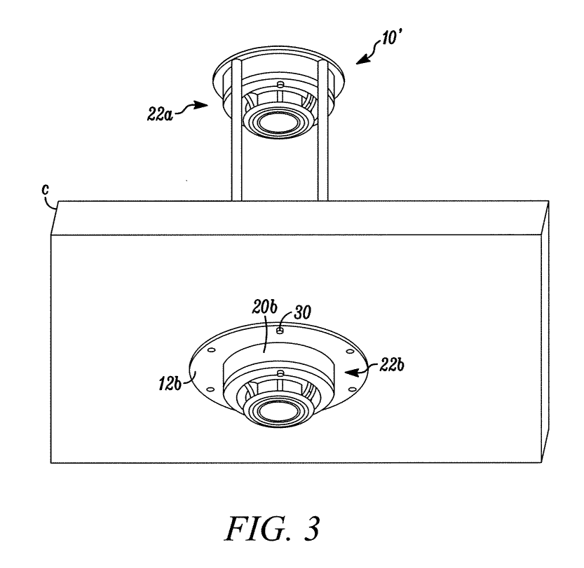

FIG. 3 illustrates an embodiment 10′ wherein annular member 12b carries an integrated light emitting diode-type indicator 30 which is coupled to the detector 22a to provide optical feedback as to the state of that detector. A plurality of different indicators can be mounted on the annular member 12b as desired, and would be understood by those skilled in the art as optional indicators of condition or state.

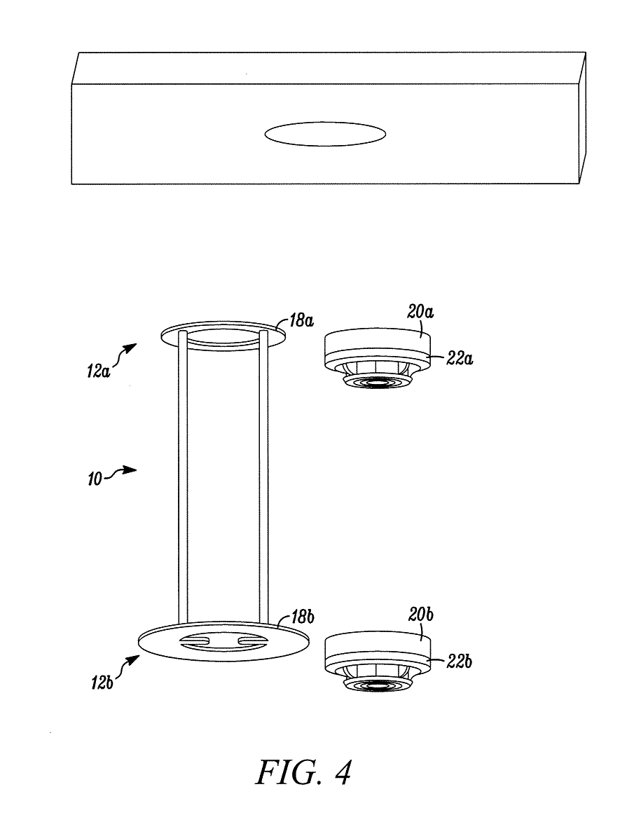

FIG. 4 illustrates the apparatus 10 with the bases 20a, 20b and detectors 22a, 22b decoupled therefrom. One of the advantages of the apparatus 10,10′ is that the detectors, such as 22a,b are standard detectors, and the bases 20a,b can be standard bases as would normally be used in such installations. No special equipment is necessary.

Relative to FIG. 4, instead of installing base 20b, either a decorative cover plate or light fixture could be installed on end 12b. In this embodiment, the base and detector 20a, 22a (upon installation) will extend into the utility region between the drop ceiling C and the actual ceiling. The observable end 12b, located below the drop ceiling C would display either the decorative cover plate or the light fixture. In either instance, if desired the light emitting diodes 30 could still be installed on end 12b to provide easily seen status indicia for the operational detector 22a. Other such variations come within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus comprising:
first and second ambient condition detectors; and
a structure which supports the detectors axially spaced apart from one another along a common axis.

2. An apparatus as in claim 1 which carries first and second detector bases, the respective detectors are releasably coupled thereto.

3. An apparatus as in claim 2 where the structure includes an element for adjusting the spacing between the detectors.

4. An apparatus as in claim 3 where the structure carries a surface mounting feature.

5. An apparatus as in claim 3 where the detectors are in one of wired or wireless communication with a regional monitoring system.

6. An apparatus as in claim 1 where the structure comprises a plurality of axially extending support members, each of which has first and second ends, with one detector carried adjacent to one set of member ends, and, the other carried adjacent to the other set of member ends.

7. An apparatus as in claim 2 where the structure comprises a plurality of axially extending support members, each of which has first and second ends, with one detector carried adjacent to one set of member ends, and, the other carried adjacent to the other set of member ends.

8. An apparatus as in claim 7 where the detectors are selected from a class which includes at least smoke detectors, fire detectors, gas detectors, condensation detectors, thermal detectors and intrusion detectors.

9. An apparatus as in claim 4 where the mounting feature comprises a plate.

10. An apparatus as in claim 9 where the plate is cylindrical.

11. An apparatus comprising:
first and second detector bases; and
an elongated connection structure with the bases each attached thereto, axially spaced apart from one another along a common center line.

12. An apparatus as in claim 11 which includes a member for attachment to a separate surface.

13. An apparatus as in claim 11 which includes an attachment plate carried at an end of the structure adjacent to one of the bases.

14. An apparatus as in claim 11 where spacing between the bases can be varied.

15. An apparatus as in claim 14 which includes an attachment plate carried at an end of the structure adjacent to one of the bases.

16. An apparatus comprising:
a first detector base;
one of a decorative plate or a light fixture; and
an elongated connection structure with the base attached thereto, axially spaced apart from the decorative plate or the light fixture along a common center line.

17. An apparatus as in claim 16 which includes an element for attachment to a separate surface.

18. An apparatus as in claim 16 where spacing between the base and the plate or light fixture can be varied.

19. An apparatus as in claim 16 which includes an ambient condition detector couplable to the base.
